(19) United States
(12) Patent Application Publication
(10) Pub. No.: US 2026/0171873 A1
(43) Pub. Date: Jun. 18, 2026

(54) ROTOR OF AN ELECTRIC MACHINE

(71) Applicant: Robert Bosch GmbH, Stuttgart (DE)

(72) Inventors: Dominik Flore, Schwieberdingen (DE); Andreas Herzberger, Remseck Am Neckar (DE); Ann-Kathrin Boehmer, Stuttgart (DE); Bastian Vogt, Backnang (DE); Benedikt Lahl, Peine (DE); Daniel Kuehbacher, Stuttgart (DE); Felix Bensing, Stuttgart (DE); Harald Laue, Esslingen (DE); Jannik Stammler, Stuttgart (DE); Johannes Riedl, Bergheim (DE); Konstantin Treiber, Muenchen (DE); Niklas Schroeder, Giesen (DE); Sebastian Runge, Althengstett (DE)

(21) Appl. No.: 19/102,444

(22) PCT Filed: Jul. 21, 2023
(86) PCT No.: PCT/EP2023/070251

§ 371 Date: Feb. 10, 2025

(30) Foreign Application Priority Data
Aug. 10, 2022 (DE) 10 2022 208 304.0
Jul. 20, 2023 (DE) 10 2023 206 887.7

(51) Int. Cl. H02K 9/19; H02K 1/27; H02K 5/20

(52) U.S. Cl. CPC H02K 9/19; H02K 1/27; H02K 5/203

(57) ABSTRACT

a rotor of an electric machine, in particular a permanent magnet synchronous machine, having a rotor shaft (3) rotatable about a rotor axis (2) and a rotor body (4) disposed on the rotor shaft (3), which is in particular configured as a rotor plate package comprising a plurality of sheet blades (5), wherein a shaft cooling channel (13) runs in the rotor shaft (3) and wherein the rotor body (4) comprises a plurality of rotor poles (6) each having a pole center (7), wherein at least one V-shaped, A C-shaped or arcuate magnetic pocket (10) having a plurality of magnets (9), in particular permanent magnets, is provided in a plurality of the rotor poles, wherein the respective magnetic pocket (10) between two magnets (9) comprises a magnet-free central area (11) and narrow sides (9s) of the magnets (9) facing away from the central area (11), comprise two magnet-free edge areas (12), characterized in that at least one pocket cooling channel (15) is formed in the respective magnetic pocket (10), that is connected to the shaft cooling channel (13) via a fluidic connection and provided for cooling at least one magnet (9) of the magnetic pocket (10).

### BACKGROUND

The invention proceeds from a rotor of an electric machine.

A rotor of an electric machine is already known from WO21225902 A1, having a rotor shaft rotatable about a rotor axis and a rotor body disposed on the rotor shaft, which is in particular configured as a rotor plate package comprising a plurality of sheet blades, wherein a shaft cooling channel runs through the rotor shaft and wherein the rotor body comprises a plurality of rotor poles each having a pole center, wherein at least one V-shaped, C-shaped or arcuate magnetic pocket with a plurality of magnets is provided in a plurality of the rotor poles, wherein the respective magnetic pocket between two magnets comprises a magnet-free central area and narrow sides of the magnets facing away from the central area comprise two magnet-free edge areas.

The rotor is cooled by air directed through axial channels of the rotor.

### SUMMARY

In contrast, the rotor of an electric machine according to the invention has the advantage that the cooling of the rotor is improved in that direct oil cooling of the magnets is provided in the rotor. According to the present invention, this is achieved in that at least one pocket cooling channel is formed in the respective magnetic pocket that has a fluidic connection to the shaft cooling channel and least one magnet of the magnetic pocket is provided for cooling.

The respective pocket cooling channel may be formed according to a first and second embodiment in the central area of the respective magnetic pocket or in one of the edge areas of the respective magnetic pocket or according to a third embodiment in a recess of one of the magnets or between two recesses of two magnets.

According to an advantageous first embodiment, the respective magnetic pocket for fastening the magnets can be filled with a curable filler, in particular a casting compound or a mold material, wherein the respective pocket cooling channel is a cavity formed in the filler or on the edge of the filler, or is directly bounded outside of the filler by walls of the respective magnetic pocket. In this way, less filler is needed. In addition, the filler can be used to attach the magnets and to embed or form the respective pocket cooling channel. The respective pocket cooling channel is further formed directly on or near one of the narrow sides of the respective magnet so that the cooling of the magnet is further improved.

According to a first design example of the first embodiment, the respective pocket cooling channel may be formed by subsequently deforming an in particular cone-shaped deforming tool from the respective magnetic pocket, in particular from the filler of the respective magnetic pocket. In this way, the respective pocket cooling channel is formed without additional components in the filler or at the edge of the filler of the respective magnetic pocket.

According to a second design example of the first embodiment, the respective pocket cooling channel may be formed by a separate cooling tube embedded in the filler. In this way, it is possible in particular to create very long and thin cooling channels that would otherwise fail on an intricate tool.

According to a third design example of the first embodiment, the respective pocket cooling channel can be formed between one of the narrow sides of the respective magnet and a tube half-shell abutting the narrow side of the magnet and embedded in the filler. In this way, the pocket cooling channel is formed directly on the magnet so that very good cooling of the magnet is achieved.

It is advantageous if when two tube half-shells are provided on opposite narrow sides of the respective magnet, wherein the magnet and the two tube half-shells are enclosed by a jacket to form a magnet unit. In this way, two pocket cooling channels are formed directly on both narrow sides of the respective magnet, so that the cooling of the magnet is improved even further and occurs evenly from both narrow sides.

According to a fourth design example of the first embodiment, the respective pocket cooling channel is formed by a cavity in the central area of the respective magnetic pocket, wherein the cavity is directly bounded by walls of the respective magnetic pocket. The central area of the respective magnetic pocket is designed without a bridge. The pocket cooling channel formed in this way must additionally still be sealed against the rotor plate package.

According to a fifth design example of the first embodiment, the respective pocket cooling channel is formed by a cavity in the central area of the respective magnetic pocket, wherein the cavity is formed in the filler provided in the central area. The pocket cooling channel formed in this way is enclosed by the filler and thereby sealed against the rotor plate package.

According to the first embodiment, the central area of the respective magnetic pocket can comprise a bridge or be designed without a bridge. When a bridge is present, the respective V-shaped, C-shaped or arcuate magnetic pocket is formed by two magnetic pockets separated from each other by the bridge and together forming a V-shaped magnetic layer.

If a bridge is present, a pocket cooling channel formed in the central area is arranged lateral to the bridge. If no bridge is present, a pocket cooling channel formed in the bridgeless central area can be disposed centrally between the poles. A bridgeless central area significantly reduces scattering of the flow in the rotor and allows for a very large cooling channel that has a lower pressure drop than a 2 part cooling channel divided by the bridge.

According to a second embodiment, it is advantageously provided that the central area of the respective magnetic pocket is respectively formed without a bridge and a pocket cooling channel formed in the central area is formed by a hollow central area and a pocket cooling channel formed in the edge area by a hollow edge area. In this way, the pocket cooling channels may be formed without a curable filler, thereby reducing manufacturing costs. In addition, the thermal resistance is reduced because the curable filler typically has comparatively low thermal conduction.

It is particularly advantageous if a magnetic non-conductive rod-shaped pocket body, in particular made of a plastic or an elastomer, is disposed in the hollow central area and/or in the hollow edge areas of the respective magnetic pocket in order to narrow the cross-section of the pocket cooling channel formed in the central area or the edge area. In this way, a high flow rate can be achieved in the corresponding pocket cooling channel, in particular in order to achieve a turbulent flow and thus better cool the magnets of the rotor. In addition, no scattering flows can flow over the magnetically non-conductive pocket body.

According to an advantageous embodiment, the respective pocket body can be formed as a round rod or rod with a rectangular cross-section, in particular made of a solid material, and in particular made from a plastic or an elastomer. The respective pocket body is configured such that it abuts the respective magnetic pocket against the respective outer pole segment and the respective inner pole segment, in particular that it is clamped between the two pole segments.

It is further advantageous if the rotor body is enclosed by a rotor sleeve, in particular a fiber composite sleeve, in particular for pre-tensioning outer pole segments of the rotor body against the magnets of the respective magnetic pocket. In this way, in the case of the second embodiment, each of the outer pole segments are pre-tensioned against one of the inner pole segments via the magnets and via the pocket bodies. For this purpose, the respective pocket body has a lower stiffness than the magnets, for instance. This ensures that the magnets of the respective magnetic pocket are clamped and thus fixed.

Furthermore, it is advantageous if the rotor sleeve extends in the axial direction beyond the rotor body for the annular enclosure of two cover plates arranged on the front of the rotor, each in a respective joining area. The respective cover plate then connects flush with the outer diameter of the rotor body and the joining area of the cover plates is covered by the rotor sleeve, so that the cover plates and thus the cooling circuit in the rotor are sealed against the outside.

It is also advantageous if each pocket cooling channel has a pocket channel inlet for supplying cooling fluid from the shaft cooling channel and a pocket channel outlet for draining the cooling fluid, wherein the pocket channel inlets of a first group of pocket cooling channels are formed on one of the two front faces and the pocket channel inlets of a second group of pocket cooling channels are formed on the other end face of the rotor to generate an opposite flow through the pocket cooling channels in the two groups of pocket cooling channels.

According to a first grouping variant, the first group of pocket cooling channels may be arranged, for example, in a first group of rotor poles and the second group of pocket cooling channels, for example, in a second group of rotor poles. According to an alternative second grouping variant, the first group of pocket cooling channels may be formed by the pocket cooling channels located in the central areas and the second group of pocket cooling channels may be formed by the pocket cooling channels located in the edge areas. In this way, the flows pass through the pocket cooling channels in opposite directions when the rotor is in operation. For example, the first group and the second group comprise the same number of pocket cooling channels or both groups have an equal total flow cross-section. This results in uniform cooling of the rotor, especially in the axial direction.

The rotor body has a cover plate on both front sides. In the first cover plate, first connection channels are formed to the pocket channel inlets of the first group of pocket cooling channels and in the second cover plate, second connection channels are formed to the pocket channel inlets of the second group of pocket cooling channels.

According to a first connection variant, the first and second connection channels of the two cover plates each have a fluidic connection to the shaft cooling channel. In this way, a parallel connection of all pocket cooling channels of the rotor is achieved.

According to a second connection variant, the first connection channels have a fluidic connection to the shaft cooling channel and the second connection channels have a fluidic connection to the pocket channel outlets of the first group of pocket cooling channels. In particular, each of the second connection channels has a fluidic connection to at least one of the pocket channel outlets of the first group of pocket cooling channels. According to the alternative second grouping variant, the second connection channel can connect different pocket cooling channels located within the same rotor pole. In this way, a series connection of the pocket cooling channels of the first group with the pocket cooling channels of the second group is achieved.

In addition, it is advantageous if the pocket channel outlets each have a fluidic connection to an outlet channel in one of the two cover plates, wherein the outlet channels of the cover plates each comprise outlet openings for cooling one of the winding heads of a stator, wherein the outlet openings lie particularly on an end face or on an outer circumference of the respective cover plate, or open into a return section of the shaft cooling channel. In this way, a cooling circuit is formed.

Moreover, it is advantageous if each collecting channel has fluidic connections with a plurality of pocket channel outlets, in particular of a rotor pole, whose pocket cooling channels have a different radial position, wherein the collecting channels of the cover discs run radially inwardly with respect to the rotor axis from the respective pocket channel outlet, towards the outlet openings. In this way, due to static pressure recovery, a uniform flow is achieved through the pocket cooling channels connected to the same collection channel.

The invention also relates to an electric machine comprising a rotor according to the invention.

### BRIEF DESCRIPTION OF THE DRAWINGS

An exemplary embodiment of the invention is shown in simplified form in the drawing and explained in more detail in the following description Shown are:

FIG. 1 a rotor of an electric machine with parallel connection of the pocket cooling channels according to the invention,

FIG. 2 a cross-sectional view of the rotor of FIG. 1 taken along line II-II in FIG. 1,

FIG. 3 one of the rotor poles of the rotor of FIG. 1 according to a first design example of a first embodiment,

FIG. 4 one of the rotor poles of the rotor of FIG. 1 according to a second design example of the first embodiment,

FIG. 5 one of the rotor poles of the rotor of FIG. 1 according to a third design example of the first embodiment,

FIG. 6 one of the rotor poles of the rotor of FIG. 1 according to a first design example of a second embodiment,

FIG. 7 one of the rotor poles of the rotor of FIG. 1 according to a third embodiment,

FIG. 8 a rotor of an electric machine having a series connection of the pocket cooling channels according to the invention,

FIG. 9 a partial view of a section through a cover plate of the rotor along a line IX-IX in FIG. 2 for the first design example of the second embodiment of FIG. 6,

FIG. 10 one of the rotor poles of the rotor of FIG. 1 according to a second design example of the second embodiment,

FIG. 11 a cross-sectional view of the rotor of FIG. 10,

FIG. 12 one of the rotor poles of the rotor of FIG. 1 according to a fourth design example of the first embodiment, and

FIG. 13 one of the rotor poles of the rotor of FIG. 1 according to a fifth design example of the first embodiment.

### DETAILED DESCRIPTION

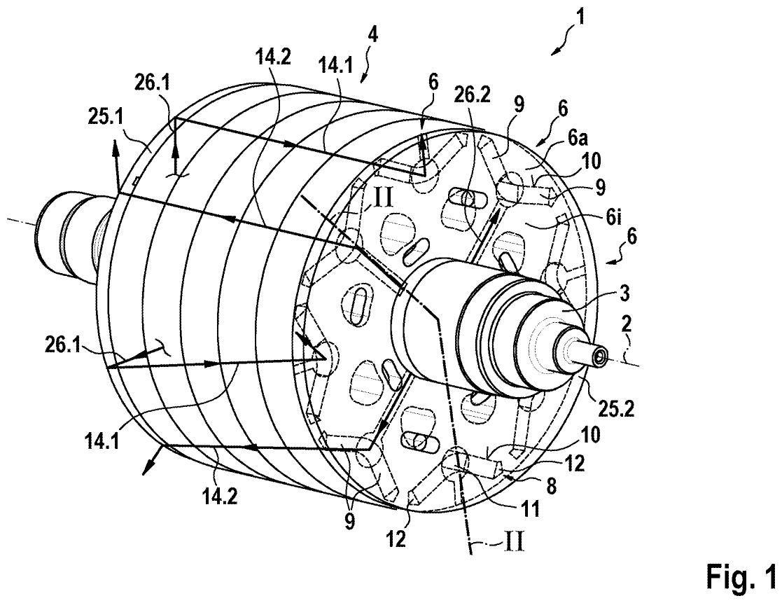

FIG. 1 shows a rotor of an electric machine with parallel connection of the pocket cooling channels according to the invention.

The rotor 1 of an electric machine, in particular of a permanent magnet synchronous machine, comprises a rotor shaft 3 rotatable about a rotor axis 2 and a rotor body 4 disposed on the rotor shaft 3. For example, the rotor body 4 is configured as a rotor plate package comprising a plurality of sheet blades 5.

A shaft cooling channel 13 runs in the rotor shaft 3. The rotor body 4 comprises a plurality of rotor poles 6 each having a pole center 7.

At least one V-shaped, C-shaped or arcuate magnetic pocket 10 is provided in a plurality of the rotor poles 6, for example in each rotor pole 6, for receiving a plurality of magnets 9, in particular permanent magnets.

A magnetic layer 8 of a plurality of magnets 9 is formed in the respective magnetic pocket 10. For example, each magnetic layer 8 comprises two magnets 9 which are arranged in a V-shape, for example, according to FIG. 1. The magnetic layer 8 is arranged, for example, symmetrically to the respective pole center 7. The respective rotor pole 6 is divided by the respective magnetic layer 8 in a radial direction with respect to the rotor axis 2 into an inner pole segment 6i and an outer pole segment 6a.

The respective magnetic pocket 10 can also be a magnetic layer 8, which comprises two magnetic pockets that are separated from one another by a bridge.

The respective magnetic pocket 10 comprises a magnet-free central area 11 between two magnets 9 and two magnet-free edge areas 12 on the narrow sides 9s of the magnets 9 facing away from the central area 11. The central area 11 is respectively formed in the area of the pole center 7 and extends circumferentially between two narrow sides 9s of two magnets 9 of the magnetic pocket 10 facing the pole center 7. The magnetic layer 8 comprises two legs set at an angle, wherein the edge areas 12 are provided at the leg ends of the magnetic layer 8 which face one another, in particular at or near the narrow sides 9s, which face away from the central area 11. The respective edge area 12 of the respective magnetic pocket 10 can have a bridge to the outer circumference of the rotor body 4 or can be designed without a bridge.

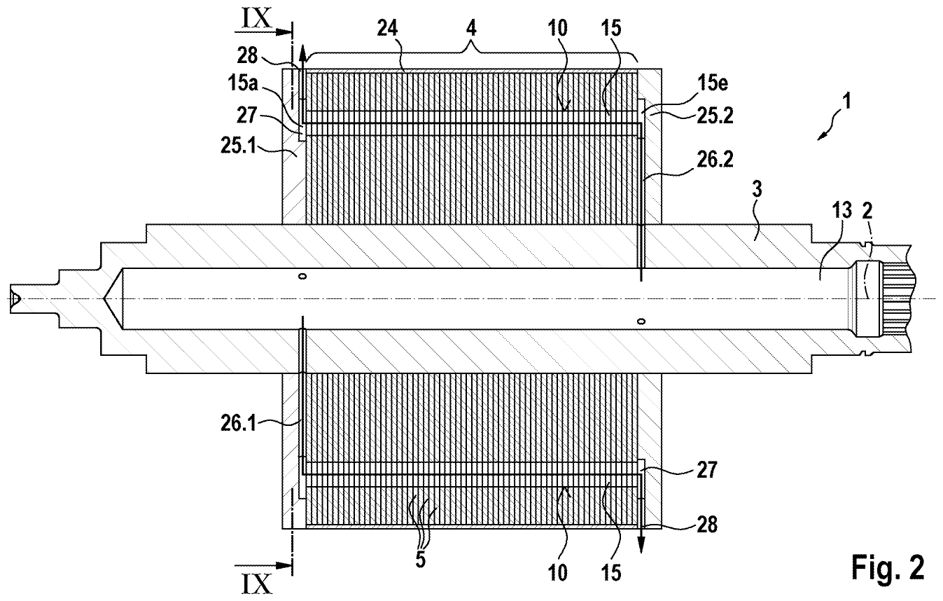

FIG. 2 shows a cross-sectional view of the rotor of FIG. 1 taken along line II-II in FIG. 1.

According to the invention, it is provided that at least one pocket cooling channel 15 is configured in the respective magnetic pocket 10, which has a fluidic connection to the shaft cooling channel 13 and is provided for cooling at least one magnet 9 of the magnetic pocket 10. For example, a plurality of pocket cooling channels 15 can also be formed in the respective magnetic pocket 10.

According to the first and second embodiment, the respective pocket cooling channel 15 can be formed in the central area 11 of the respective magnetic pocket 10 or in one of the edge areas 12 of the respective magnetic pocket 10.

According to the first and second embodiments, the central area 11 of the respective magnetic pocket 10 can comprise a bridge 22 for connecting the outer pole segment 6a and the inner pole segment 6i or can be designed without a bridge.

Each pocket cooling channel 15 comprises a pocket channel inlet 15e for supplying cooling fluid from the shaft cooling channel 13 and a pocket channel outlet 15a for draining the cooling fluid. The pocket channel inlets 15e of a first group 14.1 of pocket cooling channels 15 on one of the two end faces and the pocket channel inlets 15e of a second group 14.2 of pocket cooling channels 15 on the other end face of the rotor 1 may be configured to generate flows through the pocket cooling channels 15 in the two groups 14.1, 14.2 of pocket cooling channels 15 in opposing directions. According to the first grouping variant, the first group 14.1 of pocket cooling channels 15 may be arranged in particular in a first group of rotor poles 6 and the second group 14.2 of pocket cooling channels 15 may be arranged in particular in a second group of rotor poles 6. For example, the first group 14.1 of pocket cooling channels 15 is formed by the pocket cooling channels 15 of each second rotor pole 6 as seen in the circumferential direction. For example, the second group 14.2 of pocket cooling channels 15 is formed by the pocket cooling channels 15 of each remaining second rotor pole 6 as seen in the circumferential direction.

In all embodiments, the rotor body 4 has a cover plate 25 on each end face, wherein first connection channels 26.1 to the pocket channel inlets 15e of the first group 14.1 of pocket cooling channels 15 are formed in the first cover plate 25.1 and second connection channels 26.2 to the pocket channel inlets 15e of the second group 14.2 of pocket cooling channels 15 are formed in the second cover plate 25.2. The first and second connection channels 26.1, 26.2 of the two cover plates 25 have a fluidic connection to the shaft cooling channel 13 so that a parallel connection of all pocket cooling channels 15 is achieved.

Each connection channel 26.1 can open into a plurality of pocket channel inlets 15e and thus function as a distribution channel.

The cover plates 25.1, 25.2 are designed to be flush with the rotor body 4, for example, in a radial direction with respect to the rotor axis 2.

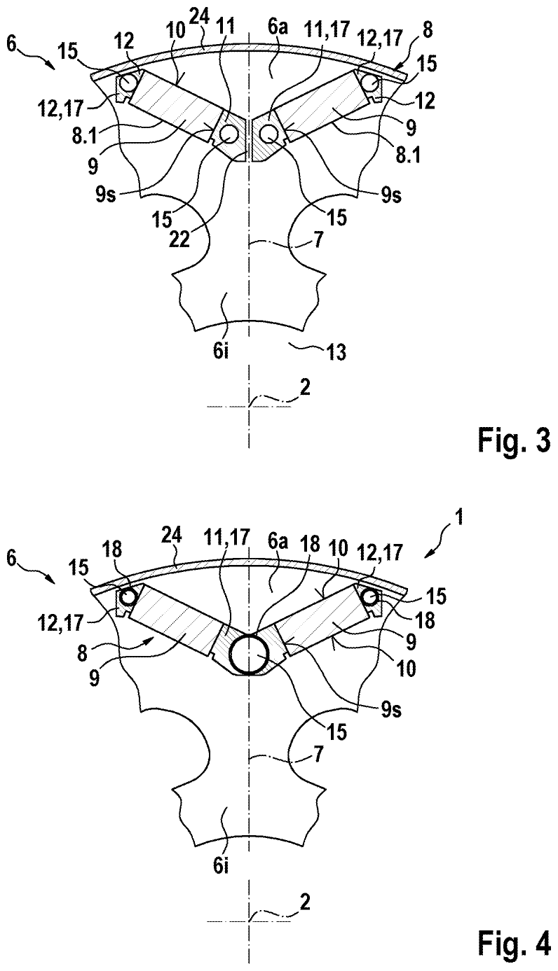

FIG. 3 shows one of the rotor poles of the rotor of FIG. 1 according to a first design example of the first embodiment.

According to the first embodiment, the respective magnetic pocket 10 for attaching the magnets 9 is filled with a curable filler 17, in particular a casting compound or a mold material, wherein the respective pocket cooling channel 15 is a cavity embedded in the filler 17 or formed between an edge of the respective magnetic pocket 10 and an edge of the filler 17.

According to the first design example of the first embodiment in FIG. 3, the respective pocket cooling channel 15 is formed by deforming or withdrawing a, for example, cone-shaped deforming tool from the respective magnetic pocket 10, in particular from the filler 17 of the respective magnetic pocket 10. According to FIG. 3, two pocket cooling channels 15 are embodied in the central area 11, for example, and one pocket cooling channel 15 is respectively embodied in each of the two edge areas 12. Instead of the two pocket cooling channels 15 in the central area 11, only one pocket cooling channel 15 may be configured in the central area 11. Of course, fewer than the four pocket cooling channels 15 could also be provided in the respective magnetic pocket 10, for example only in the central area 11 or only in the edge areas 12.

FIG. 4 shows one of the rotor poles of the rotor of FIG. 1 according to a second design example of the first embodiment.

According to the second design example of the first embodiment, the respective pocket cooling channel 15 is formed by a separate cooling pipe 18 embedded in the filler 17.

According to FIG. 4, for example, a cooling pipe 18 is embodied in the central area 11 and a cooling pipe 18 is also embodied in each of the two edge areas 12. Of course, fewer than the three pocket cooling channels 15 could also be provided in the respective magnetic pocket 10, for example only in the central area 11 or only in the edge areas 12.

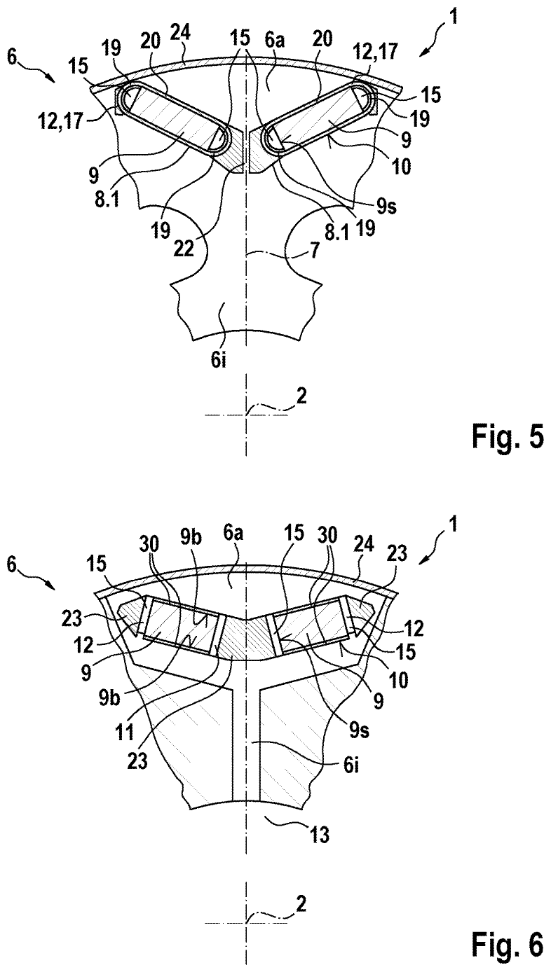

FIG. 5 shows one of the rotor poles of the rotor of FIG. 1 according to a third design example of the first embodiment.

According to the third design example of the first embodiment, the respective pocket cooling channel 15 is formed between one of the narrow side 9s of the respective magnet 9 and a tube half-shells 19 abutting the narrow side 9s of the magnet 9 and embedded in the filler 17. The tube half-shell 19 also refers to tube shells that comprise somewhat more or less than half the cross section of the tube.

According to the third exemplary embodiment, two tube half-shells 19 are provided on the two opposing narrow sides 9s of the respective magnet 9, wherein the magnet 9 and the two tube half-shells 19 are enclosed by a jacket 20 to form a magnetic unit.

FIG. 6 shows one of the rotor poles of the rotor of FIG. 1 according to a first design example of a second embodiment.

According to the first design example of the second embodiment, the central area 11 of each respective magnetic pocket 10 is configured without a bridge, wherein a pocket cooling channel 15 formed in the central area 11 is formed by a hollow central area 11 and a pocket cooling channel 15 formed in the edge area 12 is formed by a hollow edge area 12. In this case, the hollow central area 11 is circumferentially bounded by the narrow sides 9s of the two magnets 9 facing the pole center 7 and radially bounded with respect to the rotor axis 2 by the magnetic pocket 10. The hollow edge area 12 is bounded by a narrow side 9s of the respective magnet 9 facing away from the central area 11 and the sides of the magnetic pocket 10 in the area of the leg end.

A magnetic non-conductive rod-shaped pocket body 23, in particular made of a plastic or an elastomer, can be arranged in each case in the hollow central area 11 and/or in the hollow edge areas 12 of the respective magnetic pocket 10, to narrow the cross-section of the pocket cooling channel 15 formed in the central area 11 or the edge area 12. In this case, the pocket cooling channel 15 is formed between the pocket body 23 and the narrow side 9s of the respective magnet 9.

However, the pocket bodies 23 of FIG. 6 can also explicitly be omitted.

According to FIG. 6, one pocket body 23 is embodied in the central area 11, for example, and one pocket body 23 is embodied in each of the two edge areas 12. Of course, less than the three pocket bodies 23 could also be provided in the respective magnetic pocket 10, for example only one pocket body 23 lying in the central area 11. The pocket body 23 lying in the central area 11 is arranged, for example, symmetrically towards the pole center 7.

According to the second embodiment, the rotor body 4 is enclosed by a rotor sleeve 24, in particular a fiber composite sleeve, which is manufactured or mounted with pre-tensioning in order to pre-tension the outer pole segments 6a against the magnets 9 of the magnetic layers 8.

The respective pocket body 23 abuts the respective outer pole segment 6a and the respective inner pole segment 6i in the respective magnetic pocket 10 and is clamped between the two pole segments 6a, 6i by the pre-tensioned rotor sleeve 24, for example.

A casting compound, in particular an epoxy resin, may be provided on the wide sides of the magnets 9 for fixing the magnets or for sealing.

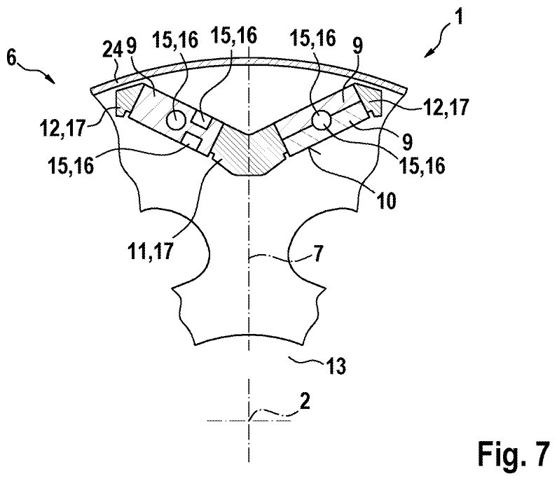

FIG. 7 shows one of the rotor poles of the rotor of FIG. 1 according to a third embodiment.

According to the third embodiment, the respective pocket cooling channel 15 is formed in a recess 16 of one of the magnets 9 or between two recesses 16 of two magnets 9.

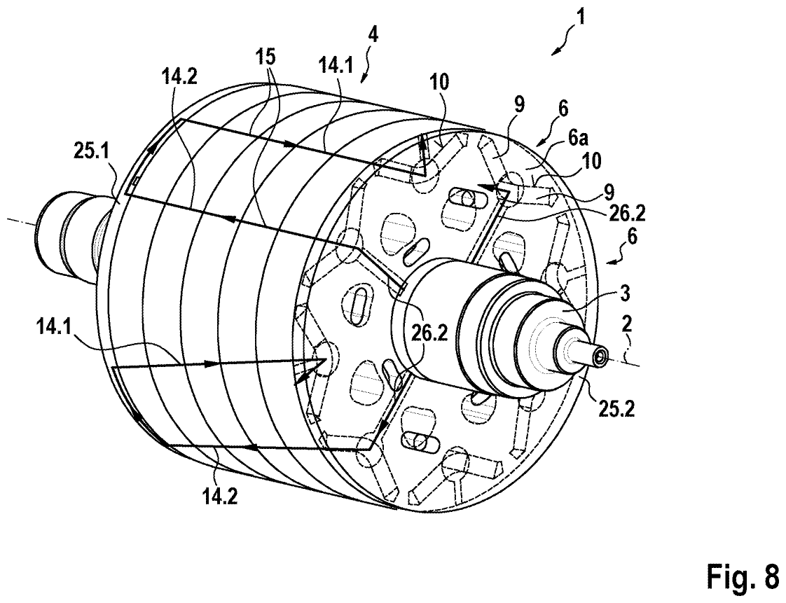

FIG. 8 shows a rotor of an electric machine having an alternative series connection of the pocket cooling channels according to the invention.

As an alternative to parallel connection of the pocket cooling channels 15 of FIG. 1, in all embodiments 8, the first connection channels 16.1 of the first cover plate 25.1 can be connected to the shaft cooling channel 13 via a fluidic connection, and the second connection channels 16.2 of the second cover plate 25.2 can be connected to the pocket channel outlets 15a of the first group 14.1 of pocket cooling channels 15 via a fluidic connection, such that a series connection of the pocket cooling channels 15 of the first group 14.1 with the pocket cooling channels 15 of the second group 14.2 is achieved. In particular, the second connection channels 16.2 are each connected to one of the pocket channel outlets 15a of the first group 14.1 of pocket cooling channels 15 via a fluidic connection. According to the alternative second grouping variant, the second connection channel 16.2 can connect the respective pocket cooling channels 15 located within the same rotor pole 6.

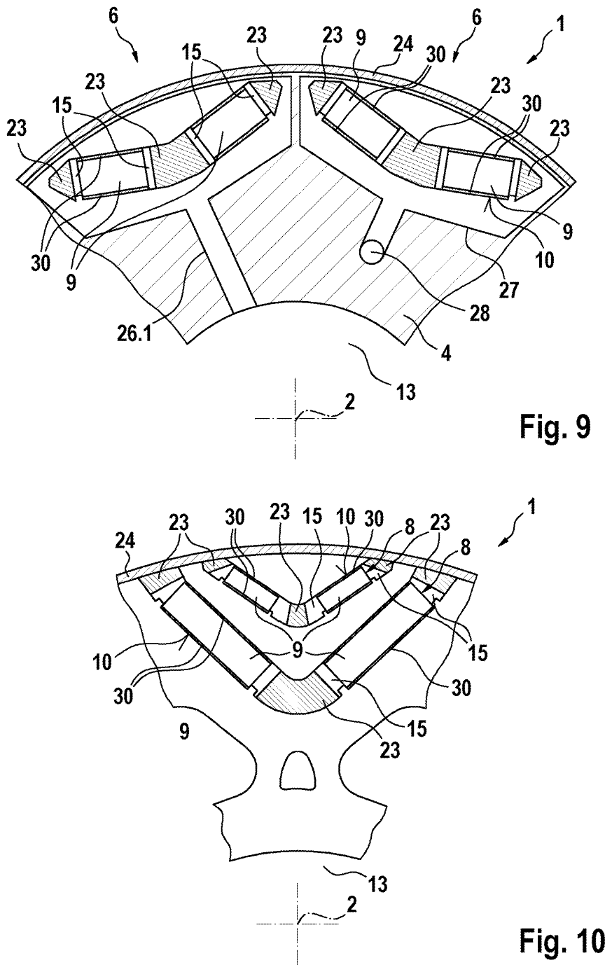

FIG. 9 shows a partial view of a section through a cover plate of the rotor along a line IX-IX in FIG. 2 for the first design example of the second embodiment of FIG. 6.

In all embodiments, each pocket channel outlet 15a is connected to a collecting channel 27 in one of the two cover discs 25.1, 25.2 via a fluidic connection, wherein the collecting channels 27 of the cover discs 25.1, 25.2 each have outlet openings 28 that may lie on an end face or on an outer circumference of the respective cover plate 25.1, 25.2 or that open into a return section of the shaft cooling channel 13. A plurality of collection channels 27 can be formed in each of the cover plates 25.1, 25.2.

Each collecting channel 27 can be connected via a fluidic connection to a plurality of pocket channel outlets 15a, in particular of a rotor pole 6, whose pocket cooling channels 15 have a different radial position relative to the rotor axis 2, wherein the collecting channels 27 of the cover plates 25.1, 25.2 extend radially inwardly relative to the rotor axis 2 from the respective pocket channel outlet 15a, starting towards the outlet openings 28.

FIG. 10 shows one of the rotor poles of the rotor of FIG. 1 according to a second design example of the second embodiment.

The second design example of the second embodiment of FIG. 10 differs from the first design example of FIG. 6 only in that two magnetic layers 8 are provided with pocket bodies 23 according to the invention.

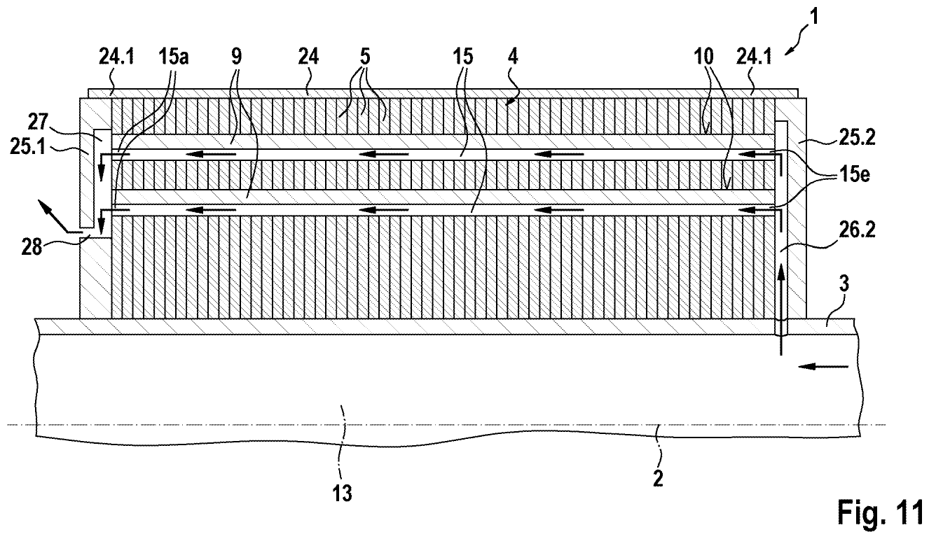

FIG. 11 shows a sectional view of the rotor of FIG. 10.

The rotor sleeve 24 can extend in the axial direction with respect to the rotor axis 2 beyond the rotor body 4 for the annular enclosure of the two cover discs 25.1, 25.2 of the rotor 1, each arranged on the end face in a joining area 24.1. A joint is provided between the respective joining area 24.1 of the rotor sleeve 24 and the respective cover plate 25.1, 25.2, for example, which can in particular be liquid-tight.

In FIG. 11 as well, the collecting channels 27 of the cover plates 25.1, 25.2 extend radially inward from the respective pocket channel outlet 15a towards the outlet openings 28 with respect to the rotor axis 2.

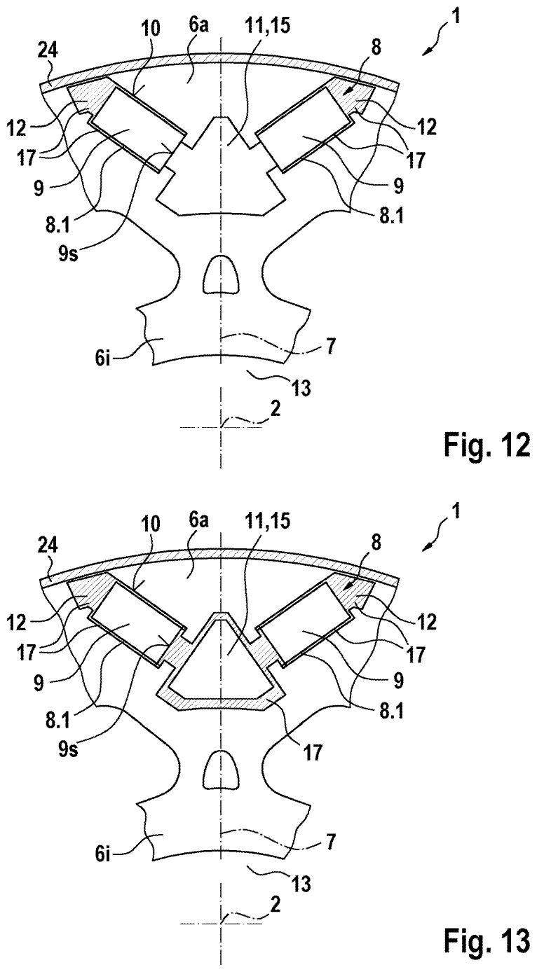

FIG. 12 shows one of the rotor poles of the rotor of FIG. 1 according to a fourth design example of the first embodiment.

According to the fourth design example of the first embodiment, the central area 11 of the respective magnetic pocket 10 is configured without a bridge. A single pocket cooling channel 15 is formed in the central area 11 by a hollow central area 11 outside the filler 17 by filling the magnetic pocket 10 with filler 17 via a gate outside the central area 11, for example in at least one of the edge areas 12, and keeping the central area 11 completely free of filler 17, for example by means of a subsequently removable deforming tool or by means of pressureless filling with filler. The central area 11 of the magnetic pocket 10 is designed, for example, to be triangular or trapezoidal. The narrow side 9s of the respective magnet 9 facing the central area 11 remains free of filler 17 thanks to a seal on the rotor body 4 or on the deforming tool, for example. The respective magnetic pocket 10 may have a recess on an inner side facing a wide side of the respective magnet 9, which is provided for improving the ventilation when filling in the filler 17 and in particular is formed close to a positioning lug for positioning the magnet 9.

FIG. 13 shows one of the rotor poles of the rotor of FIG. 1 according to a fifth design example of the first embodiment.

According to the fifth design example of the first embodiment, the central area 11 of the respective magnetic pocket 10 is configured without a bridge. A single pocket cooling channel 15 is formed in the central area 11 of the respective magnetic pocket 10 by filling the filler 17 with the magnetic pocket 10 via a gate outside the central area 11, for example in at least one of the edge areas 12, and keeping the central area 11 free of filler 17 by means of a subsequently removable deforming tool in a partial cross section that is smaller than the cross section of the central area 11.

The pocket cooling channel 15 formed thereby is thereby enclosed by filler 17 and sealed by the filler 17. The central area 11 of the magnetic pocket 10 is designed, for example, to be triangular or trapezoidal.

1. A rotor of an electric machine, the rotor having a rotor shaft (3) rotatable about a rotor axis (2) and a rotor body (4) disposed on the rotor shaft (3), wherein a shaft cooling channel (13) runs in the rotor shaft (3) and wherein the rotor body (4) comprises a plurality of rotor poles (6) each having a pole center (7), wherein at least one V-shaped, C-shaped or arcuate magnetic pocket (10) having a plurality of magnets (9) is provided in a plurality of the rotor poles (6), wherein the respective magnetic pocket (10) between two magnets (9) comprises a magnet-free central area (11) and two magnet-free edge areas (12) on narrow sides (9s) of the magnets (9) facing away from the central area (11),
wherein
at least one pocket cooling channel (15) is formed in the respective magnetic pocket (10), which is connected to the shaft cooling channel (13) via a fluidic connection and provided for cooling at least one magnet (9) of the magnetic pocket (10).

2. The rotor of claim 1, wherein the respective pocket cooling channel (15) is formed
a. in the central area (11) of the respective magnetic pocket (10) or in one of the edge areas (12) of the respective magnetic pocket (10) or
b. in a recess (16) of one of the magnets (9) or between two recesses (16) of two magnets (9).

3. The rotor of claim 1, wherein the respective magnetic pocket (10) is filled with a curable filler (17) for fastening the magnets (9), wherein the respective pocket cooling channel (15) is a cavity formed in the filler (17) or at the edge of the filler (17) or is directly bounded outside of the filler (17) by walls of the respective magnetic pocket (10).

4. The rotor of claim 3, wherein the respective pocket cooling channel (15) is formed from the respective magnetic pocket (10) by deforming shaped deforming tool.

5. The rotor of claim 3, wherein the respective pocket cooling channel (15) is formed by a separate cooling tube (18) embedded in the filler (17).

6. The rotor of claim 3, wherein the respective pocket cooling channel (15) is formed between one of the narrow sides (9s) of the respective magnet (9) and a tube half-shell (19) abutting the narrow side (9s) of the magnet (9) and embedded in the filler (17).

7. The rotor of claim 6, wherein two tube half-shells (19) are provided on opposite narrow sides (9s) of the respective magnet (9), wherein the magnet (9) and the two tube half-shells (19) are enclosed by a jacket (20) to form a magnetic unit.

8. The rotor according to claim 2, wherein the central area (11) of the respective magnetic pocket (10) comprises a bridge (22) or is configured without a bridge.

9. The rotor of claim 8, wherein the central area (11) of the respective magnetic pocket (10) is configured without a bridge in each case, wherein a pocket cooling channel (15) formed in the central area (11) is formed by a hollow central area (11) and a pocket cooling channel (15) formed in the edge area (12) is formed by a hollow edge area (12).

10. The rotor of claim 9, wherein a magnetic non-conducting rod-shaped pocket body (23) is arranged in the hollow central area (11) and/or in the hollow edge areas (12) of the respective magnetic pocket (10) to narrow a cross-section of the pocket cooling channel (15) formed in the central area (11) or in the edge area (12).

11. The rotor of claim 1, wherein the rotor body (4) is enclosed by a rotor sleeve (24).

12. The rotor of claim 11, wherein the rotor sleeve (24) extends in an axial direction beyond the rotor body (4) for an annular enclosure of two cover plates (25.1, 25.2) of the rotor (1) each in a joining area (24.1), wherein a joint is provided in each case between the respective joining area (24.1) of the rotor sleeve (24) and the respective cover plate (25.1, 25.2).

13. The rotor of claim 1, wherein each pocket cooling channel (15) comprises a pocket channel inlet (15e) for supplying cooling fluid from the shaft cooling channel (13) and a pocket channel outlet (15a) for draining the cooling fluid, wherein
a. the pocket channel inlets (15e) of a first group (14.1) of pocket cooling channels (15) on one of two end faces and
b. the pocket channel inlets (15e) of a second group (14.2) of pocket cooling channels (15) at another end face of the rotor (1) are configured to generate an opposing flow through the pocket cooling channels (15) in the two groups ( 14.1,14.2) of pocket cooling channels (15), wherein the first group (14.1) of pocket cooling channels (15) is arranged in a first group of rotor poles (6) and the second group (14.2) of pocket cooling channels (15) is arranged in a second group of rotor poles (6), or wherein the first group (14.1) of pocket cooling channels (15) is formed by the pocket cooling channels (15) located in the central areas (11), and the second group (14.2) of pocket cooling channels (15) is formed by the pocket cooling channels (15) located in the edge areas (12).

14. The rotor of claim 13, wherein the rotor body (4) comprises a cover plate (25.1, 25.2) on each of the end faces, wherein first connection channels (26.1) to the pocket channel inlets (15e) of the first group (14.1) of pocket cooling channels (15) are formed in the first cover plate (25.1) and second connection channels (26.2) to the pocket channel inlets (15e) of the second group (14.2) of pocket cooling channels (15) are formed in the second cover plate (25.2), wherein
a. the first and second connection channels (26.1, 26.2) of the two cover plates (25.1, 25.2) are connected to the shaft cooling channel (13) via a fluidic connection, or
b. the first connection channels (26.1) are connected to the shaft cooling channel (13) and the second connection channels (26.2) are connected to the pocket channel outlets (15a) of the first group (14.1) of pocket cooling channels (15) via a fluidic connection.

15. The rotor of claim 13, wherein each pocket channel outlet (15a) is connected to a collecting channel (27) in one of the two cover plates (25.1, 25.2) via a fluidic connection, wherein each of the collecting channels (27) of the cover plates (25.1, 25.2) comprises outlet openings (28) that lie on an end face or on an outer circumference of the respective cover plate (25.1, 25.2), or in a return section of the shaft cooling channel (13).

16. The rotor of claim 15, wherein each collecting channel (27) is connected via a fluidic connection with a plurality of pocket channel outlets (15a) whose pocket cooling channels (15) have a different radial position relative to the rotor axis (2), wherein the collecting channels (27) of the cover plates (25.1, 25.2) extend radially inwardly relative to the rotor axis (2) from the respective pocket channel outlet (15a), starting towards the outlet openings (28).

17. An electric machine with a rotor (1) according to claim 1.

18. The rotor of claim 3, wherein the rotor body (4) is configured as a rotor plate package comprising a plurality of sheet blades (5).

19. The rotor of claim 11, wherein the rotor sleeve (24) is made of a fiber composite.

20. The rotor of claim 11, wherein the rotor sleeve (24) is configured to pre-tension outer pole segments (6a) of the rotor body (4) against the magnets (9) of the respective magnetic pocket (10).
